(19) United States
(12) Patent Application Publication
(10) Pub. No.: US 2013/0059060 A1
(43) Pub. Date: Mar. 7, 2013

(54) CHOCOLATE-LIKE FOOD AND PROCESS FOR PRODUCING THE SAME

(71) Applicants: Akiyuki Ishiwata, Tsukubamirai-shi (JP); Yasufumi Kanada, Izumisano-shi (JP)

(72) Inventors: Akiyuki Ishiwata, Tsukubamirai-shi (JP); Yasufumi Kanada, Izumisano-shi (JP)

(73) Assignee: Fuji Oil Company, Limited, Osaka (JP)

(21) Appl. No.: 13/637,748

(22) PCT Filed: Mar. 29, 2011
(86) PCT No.: PCT/JP2011/057781

§ 371 Date: Nov. 15, 2012

(30) Foreign Application Priority Data
Mar. 31, 2010 (JP) 2010-081287

(51) Int. Cl. A23G 1/56; A23G 1/46

(52) U.S. Cl. 426/584; 426/631; 426/520

(57) ABSTRACT

Provided are a chocolate-like food, which shows little change in viscosity and sustains stable qualities even when transported and stored in a melted state, and a method for producing the same. A chocolate-like food, which contains a large amount of milk components, can be transported and stored in a melted state by regulating the content of non-crystalline lactose to a specific level or below. Further, a chocolate-like food produced by a simple method, said method comprising adding moisture to a chocolate-like food and then heating the same before the completion of a grain refining step, can be transported and stored in a melted state.

### Related Applications

The present application claims the benefit of priority of the Application No. 2010-81287 which was filed with Japan Patent Office on Mar. 31, 2010. The entirety of the application on which the priority is claimed is incorporated in the present specification by reference.

### TECHNICAL FIELD

The present invention relates to a chocolate-like food, a process for producing the same, and a method of transporting and storing the same. More specifically, the present invention relates to a chocolate-like food, in particular, a chocolate-like food containing a milk component which has an increased rate of crystalline lactose so that it can be transported and stored in a melted state; a process for producing the same; and a method of transporting and storing the same.

### BACKGROUND ART

Chocolate-like foods, a representative of which is chocolate, are produced using, as main raw materials, cacao mass, cocoa powder, cocoa butter, vegetable fats and oils, milk components (whole milk powder, skim milk powder, whey powder, etc.), and sugar components (sugar, lactose, maltose, fructose, etc.). A conventional chocolate-like food is in a solid to semi-solid state at ordinary temperature owing to cocoa butter and vegetable fats and oils contained therein.

In many cases, chocolate-like foods to be served as raw materials produced by chocolate manufactures are delivered to bread manufacturers, confectionery manufacturers or the like and, in their factories, the delivered chocolate-like foods are melted by warming and, thereafter, finished into final commercial products, for example, by coating on bread, or cast-molding in molds.

Hence, in many transactions of chocolate-like foods between chocolate manufacturers and bread manufacturers or confectionery manufacturers, chocolate-like foods are molded into round pebble-shaped pieces and delivered in the form of unit packages of about 10 to 20 kg by packing the pieces into boxes so that the pieces can be easily melted upon use, or packed into cans so that the pieces can be melted in a hot water bath.

When foods utilizing such a chocolate-like food, for example, products such as biscuits coated with a chocolate-like food, ice cream bars coated with a chocolate-like food, and bread coated with a chocolate-like food are produced in a large scale in big bread manufacturers and confectionery manufacturers, a large amount of a chocolate-like food is required, which causes problems such as necessity of big melting apparatuses, large workload, and/or generation of a large amount of waste containers.

As a method for solving these problems, about 1 to 10 tons of a chocolate-like food in a melted state is transported by a tanker or tank truck, or by filling it in 1-ton boxes, followed by receiving it into, for example, a tank as it is, and storing and using the received food. Such a method has various advantages. For example, such a method can considerably save chocolate manufacturers their labor of molding, filling and packaging of a chocolate-like food. Further, big bread manufacturers and confectionery manufacturers can omit a troublesome melting operation and cut down almost all waste containers.

Such a transporting and storing method is sometimes desirable in case of a chocolate-like food containing no or only several percents of a milk component such as a sweet chocolate-like food. However, in case of a chocolate-like food containing a large amount of a milk component, such as a milk chocolate-like food, or a white chocolate-like food, in general, a quality change is quick, and hence, transportation and storage in a melted state is not always desirable. In this case, transportation and storage in a melted state are possible only under extremely restricted conditions, wherein a large amount of a chocolate-like food can be consumed in a very short term such as within 1 to 2 days; otherwise a chocolate-like food is often packed into containers such as boxes or cans and distributed in a solid state.

There has been hitherto no established technique that enables manufactures to apply a chocolate-like food, in particular, a chocolate-like food containing a large amount of a milk component to transportation and storage in a melted state over a long period of time.

As a technique relating to the present invention, Patent Document 1 discloses that water is added to a whole milk powder, a shearing force is applied to the mixture with heating, and the resulting mixture is used in a chocolate-like food. This patent document describes that, in a whole milk powder which has been subjected to the above treatment, non-crystalline lactose contained therein is crystallized, and milk fat immobilized on lactose and milk protein is released. This patent document also describes that, when using such a whole milk powder as a raw material of chocolate, the released milk fat improves a taste of the chocolate. However, the above treatment requires a special and expensive apparatus, and its operation is complicated. In addition, there is no disclosure about an effect of such a treatment on transportation and storage of a chocolate-like food in a melted state in Patent Document 1.

### PRIOR ART DOCUMENT

### Patent Document

Patent Document 1: U.S. Pat. No. 6,548,099

### SUMMARY OF INVENTION

### Problems to be Solved by the Invention

An object of the present invention is to provide a chocolate-like food, which is stable in quality even when transported and stored in a melted state.

### Means for Solving the Problems

Regarding a chocolate-like food which is usually distributed in a solid state, the present inventors have studied problems caused by storing and distributing the chocolate-like food in a melted state. As a result, it has been revealed that, when a chocolate-like food containing a milk component, in particular, a milk powder at a certain level or higher, is stored and distributed in a melted state, a viscosity change, in particular, an increase in viscosity is observed with time.

When products utilizing a chocolate-like food are produced, an operation such as mechanically weighing the above melted chocolate-like food, followed by casting the weighed food into a mold is performed. At this time, if viscosity changes with time, occasionally, the appearance of products is deteriorated due to formation of bubbles, or an exact amount of a chocolate-like food can hardly be weighed.

Further, when a frozen dessert, bread or confectionery is covered with a chocolate, the above melted chocolate-like food is processed with a covering device such as a depositor or an enrober. At this time, if the viscosity changes with time, this occasionally affects the amount, appearance and yield of covering, which makes it difficult to keep uniform quality. Furthermore, when a chocolate-like food is stored in a melted state in a container such as a tank, sometimes, an increase in viscosity of the chocolate-like food occurs, which makes it difficult, for example, to draw the chocolate-like food out of the tank. Therefore, the suppression of the viscosity change with time has been recognized to be of importance.

The present inventors have intensively studied a method of suppressing such a viscosity change with time.

As a result, it has been found that, when lactose contained in a chocolate-like food has a high rate of non-crystalline lactose, a significant viscosity change occurs with time. That is, it has been found that a chocolate-like food has durability for transportation and storage in a melted state when the rate of non-crystalline lactose in the chocolate-like food is low.

Further, the present inventors have studied whether such a chocolate-like food can be produced by a convenient and simple method. As a result, it has been found that a part of lactose contained in a chocolate-like food can be converted into crystalline lactose by adding a certain amount of water thereto and subjecting to a certain heating operation by the completion of a grain refining step in production steps of a chocolate-like food, thereby enabling manufacturers to apply a chocolate-like food to transportation and storage in a melted state even in case of a chocolate-like food containing a large amount of a milk component. Thus, the present invention has been completed.

That is, the present invention relates to: (1) A chocolate-like food for transportation and storage in a melted state, which comprises 7 to 23% by weight of non-fat milk solids, wherein a rate of non-crystalline lactose to total lactose contained therein is 85% by weight or less;

(2) A method of suppressing a change in viscosity of a chocolate-like food in a melted state with time, which comprises preparing a chocolate-like food comprising 7 to 23% by weight of non-fat milk solids, wherein a rate of non-crystalline lactose to total lactose contained therein is 85% by weight or less, and transporting and storing the chocolate-like food in a melted state;

(3) A process for producing the chocolate-like food for transportation and storage in a melted state according to (1), which comprises regulating a formulation of raw materials so that a water content of the final chocolate- like food becomes 0.9 to 2.7% by weight and, thereafter, performing a heat treatment at 55 to 90° C. for 1 hour or longer and shorter than 6 hours by the completion of a grain refining step;

(4) The process for producing the chocolate-like food for transportation and storage in a melted state according to (3), wherein the final chocolate-like food contains 9 to 50% by weight of a milk component in terms of dry weight.

(5) The process for producing the chocolate-like food for transportation and storage in a melted state according to (4), wherein the final chocolate-like food contains 10 to 75% by weight of vegetable fats and oils other than cacao butter;

(6) The process for producing the chocolate-like food for transportation and storage in a melted state according to (5), which is applied to transportation and storage in a melted state for 72 hours or longer;

(7) A process for producing the chocolate-like food for transportation and storage in a melted state according to (1), which comprises preparing a milk powder having a rate of non-crystalline lactose of 85% by weight or less to total lactose contained therein, and using the resulting milk powder as a raw material of the chocolate-like food;

(8) The process for producing the chocolate-like food for transportation and storage in a melted state according to (7), wherein the milk powder having a rate of non-crystalline lactose of 85% by weight or less to total lactose contained therein is obtained by adding water to a milk powder, followed by heating and mixing at 55 to 90° C., and the resulting milk powder is used as the raw material; and

(9) The process for producing the chocolate-like food for transportation and storage in a melted state according to any one of (3) to (8), wherein lactose is separately added as a sugar component in an amount of less than 5% by weight based on the chocolate-like food.

### Effect of the Invention

According to the present invention, it is possible to obtain a chocolate-like food with extremely less quality change, in particular, with a suppressed viscosity change, even when the chocolate-like food is transported and stored in a melted state.

### BRIEF DESCRIPTION OF DRAWINGS

FIG. 1 is a calibration curve of β-type crystals of lactose according to an X-ray diffraction method.

FIG. 2 is a calibration curve of α-1 hydrate-type crystals of lactose according to an X-ray diffraction method.

### MODE FOR PERFORMING THE INVENTION

Hereinafter, the present invention will be specifically illustrated.

The chocolate-like food referred to in the present invention is, for example, chocolate. Further, chocolate herein referred to includes, not only chocolate, chocolate type products, and chocolate-utilizing foods defined by Japan Fair Trade Council of Chocolate and Japan Fair Trade Council of Chocolate-Utilizing Food, but also chocolate type products which contain fats and oils as essential ingredients, and, if needed, auxiliary raw materials such as sugar components, milk components, cacao raw materials (cacao mass, cocoa, cocoa butter), fruit juice powders, fruit powders, seasoning materials, emulsifiers, flavors, and coloring materials in appropriate rates. In addition, flavor types of chocolate include not only sweet chocolate, milk chocolate, and white chocolate whose main ingredients are cacao raw materials, milk powders, and sugar components, but also flavor type varieties such as a coffee flavor, a caramel flavor, a green tea flavor, a fruit flavor, a vegetable flavor, and a salty flavor.

A melted state referred to in the present invention is a state where the chocolate-like food has fluidity and exhibits a liquid state, and is usually a state where the chocolate-like food is at a temperature of 35 to 65° C., more preferably 40 to 55° C.

Milk components referred to in the present invention include various products derived from milk which can be used as raw materials. Specific examples thereof include a whole milk powder, a skim milk powder, a high fat whole milk powder, a whey powder, a butter milk powder, and casein. In addition, sugarless condensed milk, sweetened condensed milk, and cream can also be used, while there would be a case that their amounts are restricted depending on their water contents. A milk powder referred to in the present invention includes powdery products of these milk components.

The milk component used in the present invention preferably has 0 to 7% by weight, more preferably 0 to 6% by weight of a water content; 0 to 50% by weight, more preferably 0 to 40% by weight, further more preferably 0 to 35% by weight of a fat content; 20 to 99% by weight, more preferably 25 to 97% by weight, further more preferably 30 to 95% by weight of a sugar content; and 0 to 50% by weight, more preferably 5 to 45% by weight of a protein content.

In order to exhibit the effect of the present invention more efficiently, the final chocolate-like food preferably contains a milk component in the total amount of 9% by weight or more in terms of dry weight. In case that the total content of a milk component is less than 9% by weight, sometimes, a quality change does not occur within a short period of time, even when the chocolate-like food is transported and stored in a melted state. However, of course, such a chocolate-like food can be included within the scope of the chocolate-like food for transportation and storage in a melted state of the present invention. Further, in order to obtain milk chocolate and white chocolate which are richer in milk feeling and tasty, the chocolate-like food preferably contains a milk component in a larger amount, and the chocolate-like food preferably contains a milk component in a total amount of 12 to 50% by weight, more preferably 14 to 50% by weight, further preferably 16 to 50% by weight, most preferably 20 to 50% by weight in terms of dry weight.

The non-fat milk solids referred to in the present invention are components other than water and milk fat contained in milk. In the present invention, their components other than water and milk fat such as sodium caseinate, a whey powder, and a whey protein also correspond to the non-fat milk solids. In addition, although the “lactose to be separately added as a sugar component” is derived from milk, it is not regarded as the non-fat milk solids in the present invention because such lactose is not regarded as non-fat milk solids, but as a sugar component by those skilled in the art.

The chocolate-like food of the present invention contains non-fat milk solids in an amount of 7 to 23% by weight, more preferably 8 to 21% by weight, further preferably 8.5 to 15% by weight. When the content of the non-fat milk solids of the chocolate-like food is too small, the resulting product tends to have less feeling of a milk flavor. On the other hand, when the amount of the non-fat milk solids is too large, physical properties of the chocolate-like food are often adversely influenced.

Non-crystalline lactose in the present invention refers to lactose which is not crystallized, and is considered to be in an amorphous state. Usually, almost all lactose contained in a milk powder produced by spray drying with a spray dryer or the like is non-crystalline lactose.

Non-crystalline lactose has a larger surface area per mass as compared with crystalline lactose, and it is assumed that, by retaining fats and oils of a low melting point and the like on the surfaces thereof, non-crystalline lactose serves as one of viscosity-increasing factors of the chocolate-like food as a whole. Therefore, the content of non-crystalline lactose of the chocolate-like food of the present invention is 85% by weight or less, preferably 84% by weight or less, further preferably 83% by weight or less, in lactose derived from a milk powder. When the amount of non-crystalline lactose is too large, an effect of suppressing a viscosity change is often deteriorated.

The amount of non-crystalline lactose can be calculated by subtracting the amount of crystalline lactose from the total amount of lactose contained in the chocolate-like food. The total amount of lactose contained in the chocolate-like food can be calculated from the formulation (recipe). Alternatively, it can be actually measured by HPLC, an enzymatic method or the like. Specifically, the measurement by an enzymatic method is suitable because influence of coexisting substances can be minimized.

The amount of crystalline lactose can also be measured by, for example, an X-ray diffraction method. In addition, non-crystalline lactose can be directly measured by a pattern of heat flow of a differential scanning calorimeter (DSC). In case of a DSC, it is advantageous to employ a modulated DSC wherein the measurement is performed by separating heat flow signals of transition and melting of fats and oils.

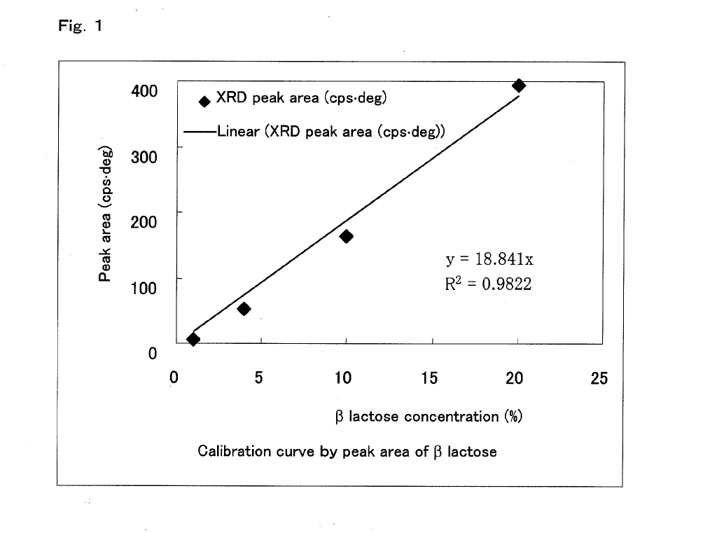

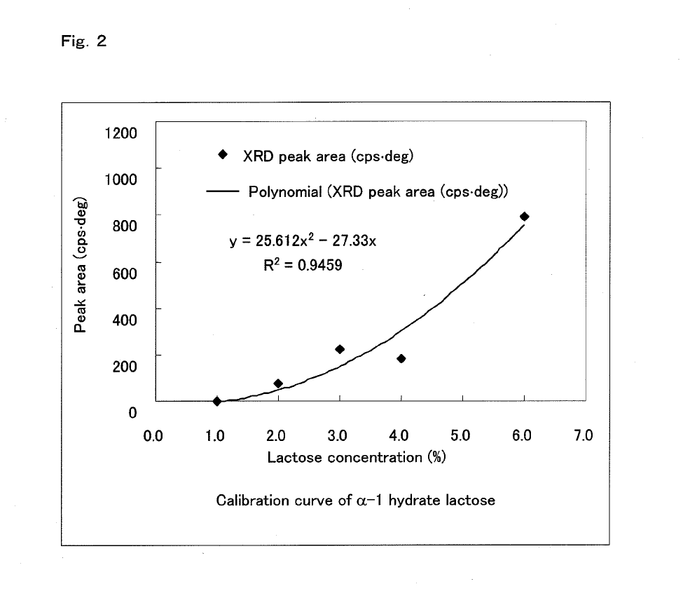

Specifically, according to an X-ray diffraction method, a powder as it is, or a powder which has been defatted with a solvent is set in a sample cell, and the measurement is performed with the following apparatus under the following measuring conditions. In case of β-type crystals, a characteristic diffraction peak can be confirmed at 2θ in the vicinity of 10.5°. Further, in α-1 hydrate-type crystals, characteristic diffraction peaks can be confirmed at 2θ in the vicinity of 19.9° and 19.0°. Peak areas of these diffraction peaks were determined with an analysis software, etc. attached to the apparatus, followed by quantitation with calibration curves as shown in FIGS. 1 and 2, which were prepared under the following conditions.

X-ray diffraction apparatus: Miniflex II (manufactured by Rigaku Corporation)

Bulb: Copper bulb

Scanning speed: 1°/1 minute

Scanning angle: 2θ=7° to 30°

α-1 hydrate lactose (manufactured by Kishida),

β lactose (manufactured by Sigma)

The “lactose to be separately added as a sugar component” in the present invention is lactose which can be added as one of raw materials of the chocolate-like food, and is different from lactose derived from a milk component such as a whole milk powder. In the present invention, the amount thereof is preferably less than 5% by weight, more preferably less than 4% by weight, further preferably less than 3% by weight. Lactose commercially available as a raw material is, in almost all cases, crystalline lactose.

The effect of the present invention can be manifested by lowering the rate of non-crystalline lactose to lactose contained in the chocolate-like food. In particular, the effect is manifested significantly by lowering the rate of non-crystalline lactose in lactose derived from the non-fat milk solids.

A measured value of the rate of non-crystalline lactose determined by an X-ray diffraction method or the like can be used as an index of the fulfillment of the function of the chocolate-like food of the present invention when it is apply to transportation and storage in a melted state. However, when the amount of the “lactose to be separately added as a sugar component” is large, sometimes, this index is insufficient to judge the fulfillment of the function. Therefore, in order to ensure at the production stage that the chocolate-like food produced certainly fulfills the function for transportation and storage in a melted state, the amount of the “lactose to be separately added as a sugar component” is preferably regulated to less than 5% by weight at which influence thereof becomes little.

Vegetable fats and oils other than cacao butter which can be used in the chocolate-like food of the present invention include any fats and oils derived from plants, which are used in conventional chocolate-like foods. Examples of the vegetable fats and oils other than cacao butter include vegetable fats and oils such as rapeseed oil, soybean oil, sunflower oil, cottonseed oil, peanut oil, rice bran oil, corn oil, safflower oil, olive oil, kapok oil, sesame oil, evening primrose oil, palm oil, shea butter, sal fat, coconut oil, and palm kernel oil, as well as processed fats and oils obtained by subjecting the above-mentioned fats and oils alone, or a mixture thereof to hydrogenation, fractionation, interesterification or the like.

In order to effectively suppress a quality change which occurs during transportation and storage in a melted state, it is preferable that the final chocolate-like food contains vegetable fats and oils other than cacao butter in an amount of 10 to 75% by weight, more preferably 13 to 70% by weight, further preferably 16 to 65% by weight, more preferably 20 to 60% by weight.

Since a fat content of the chocolate-like food containing vegetable fats and oils other than cacao butter in an amount more than 75% by weight becomes very high, the food shows such a state that solid matter particles other than the fat component are dispersed in an oil phase, sparsely, thereby reducing the contact and reaction between solid matter particles which are causative of a quality change. Hence, a quality change hardly occurs and, the use of the present invention is not always required. In case of the chocolate-like food whose content of vegetable fats and oils other than cacao butter is less than 10% by weight, the chocolate-like food requires extremely delicate flavor precision similar to that of a so-called pure chocolate whose vegetable fats and oils are solely composed of cacao butter. In such a chocolate, the flavor continues to gradually change although slightly, and it is therefore not always suitable for the application to transportation and storage in a melted state. In addition, the chocolate-like food having a low fat content is brought into a state where solid matter particles such as particles of powdery milk and sugar components, as well as cacao solid matter are densely present in an oil phase, thereby increasing in the contact and reaction between solid particles which are causative of quality change. Hence, a quality change easily occurs and, sometimes, the sufficient effect of the present invention is hardly obtainable, even if the present invention is used. For example, such a tendency gradually appears in a chocolate-like food whose fat content is 33% or less and whose viscosity is 120 p (BM-type viscometer manufactured by Toki Sangyo Co., Ltd., No. 4 rotor, 12 rpm, 45° C.) or higher. Of course, these chocolate-like foods can also be used as the chocolate-like food to be applied to transportation and storage in a melted state of the present invention.

In addition to the above-mentioned raw materials, additives such as emulsifiers, coloring materials, preservatives and antioxidants which are used in conventional chocolate-like foods can be optionally added to the chocolate-like food of the present invention as far as they adversely affect the effect of the present invention.

The present invention also relates to a process for producing the chocolate-like food for transportation and storage in a melted state. As the first aspect of the production process of the present invention, there is provided a process using as a raw material a milk component, wherein a part of lactose has been crystallized.

In many cases, a whole milk powder and a skim milk powder which are most frequently used at present and which have a good flavor are produced with a spray drier, and lactose contained therein is generally non-crystalline lactose. The lactose contained in such whole milk powder and skim milk powder can be crystallized by adding water thereto, followed by heating and mixing the resultant at 55 to 90° C. and, thereafter, pulverizing the resultant mixture.

According to such a method, a milk powder having a reduced rate of non-crystalline lactose can be obtained. The milk powder obtained by the above-mentioned method has a non-crystalline lactose content of 85% by weight or less, preferably 84% by weight or less, more preferably 83% by weight or less.

The chocolate-like food of the present invention can be produced by a per se known method using the above-obtained milk powder as a raw material. For example, the chocolate-like food can be produced by mixing raw materials with a mixer, grain-refining the mixture with a roll refiner, and finishing the resultant with a conching machine.

As the second aspect of the production process of the present invention, in production steps of the chocolate- like food, a mixture of raw materials of the chocolate-like food containing a certain amount of water is subjected to a certain degree of heating by the completion of a grain refining step. According to this aspect, a commercially available whole milk powder and skim milk powder can be utilized as they are.

The grain refining step referred to in the present invention is a refining step of crude particles of solid matters other than the fat component such as cacao mass, cocoa powder, sugar component, and milk powders which are raw materials of the chocolate-like food until the particle diameter thereof as measured with a micrometer becomes 10 to 35 μm. Specifically, this is a step performed using a grain refining apparatus such as a roll refiner, an attritor or a Mucintyre.

In this aspect, it is convenient and preferable to use a raw material containing water, particularly, a material containing 15.0% or more of water as a raw material, while there is no particular limitation of a method for regulating a water content of a mixture of the chocolate-like food raw materials at the time of the completion of the grain refining step. Examples of such a raw material include water, and water-containing foods such as natural cream, milk such as cow milk and defatted condensed milk, cream using animal and vegetable fats and oils, butter, margarine, liquid sugars such as glucose liquid sugar and reduced sugar syrup, honey, alcoholic drinks, fruit juices, coffee, tea and a mixture thereof. It is most convenient and preferable to use water to regulate the water content. The chocolate-like food containing a milk component with less quality change during transportation and storage in a melted state can be obtained by regulating the water content at the time of the completion of the grain refining step with a raw material containing water to 0.9 to 2.7% by weight based on the total amount of the final chocolate-like food, followed by performing a proper heat treatment.

The water content at the time of the completion of the grain refining step is 0.9 to 2.7% by weight, preferably 1 to 2.5% by weight, for example, 1.1 to 2.5% by weight, more preferably 1.1 to 2.3% by weight, for example, 1.1 to 1.7% by weight or 1.3 to 2.3% by weight, further preferably 1.2 to 2.1% by weight, for example, 1.2 to 1.6% by weight, 1.3 to 1.5% by weight, 1.6 to 2.0% by weight, or 1.7 to 1.9% by weight, based on the total amount of the final chocolate-like food. When the water content is too small, a quality change often increases during transportation and storage in a melted state. On the other hand, when the water content is too large, it is often causative of deterioration in physical properties of the chocolate-like food such as so-called “bote (low fluidity)”, deterioration of a texture due to aggregation of solid matters such as so-called “dama (clumping)”, and departure from a proper viscosity range.

As the heat treatment of the chocolate-like food in this aspect, it is necessary to impart a thermal history at a temperature of a mixture of the chocolate-like food raw materials of 55° C. to 90° C. for 1 hour or longer and shorter than 6 hours, after regulating the water content to the above-mentioned range and by the completion of the grain refining step. When this heat treatment is properly performed, it is possible to obtain the chocolate-like food containing a large amount of a milk component which can be applied to transportation and storage in a melted state with suppressing a viscosity change with time in a certain range. That is, it is assumed that, by the above-mentioned step, a part of non-crystalline lactose contained in raw materials of the chocolate-like food is crystallized.

The heating temperature of a mixture of the chocolate-like food raw materials in this aspect is 55 to 90° C., preferably 55 to 85° C., more preferably 60 to 80° C., further preferably 60 to 75° C., most preferably 65 to 70° C. The heating time is 1 hour or longer and shorter than 6 hours, and is preferably 1 to 5.5 hours, for example, 1.5 to 5.5 hours, 2 to 5.5 hours, 2 to 4 hours, 3 to 5.5 hours, 3 to 5 hours, of 4 to 5 hours, more preferably 2 to 5 hours, further preferably 3 to 4 hours.

When the heating temperature is too low, or when the heating temperature is too short, a quality change during transportation and storage of the chocolate-like food in a melted state tends to increase. On the other hand, when the heating temperature is too high, or when the heating time is too long, a caramel-like flavor or burnt deposits are generated, while a quality change during transportation and storage in a melted state is suppressed.

In this aspect of the production process of the chocolate-like food, any processes can be employed as far as the desired heat treatment can be performed by the completion of the grain refining step. Examples thereof include a process wherein a heat treatment is performed while mixing raw materials with a mixer and, then, a grain refining is performed with a roll refiner, followed by finishing with a conching machine; and a process wherein a heat treatment is preformed while mixing and grain-refining raw materials with an attritor, followed by finishing the resultant with a mixer. The process using an attritor is very simple and convenient, and easily performed because it can be performed according to the same manner as that of a conventional process except that the temperature is controlled to a slightly higher temperature and a certain grain refining treatment time is maintained.

In many cases, the heat treatment and addition of water after the completion of the grain refining step result in the difficulty in suppression of a quality change during transportation and storage in a melted state, and further, are causative of deterioration of a texture of the chocolate due to aggregation of solid matters such as so-called “dama (clumping)”, which greatly damage commercial value. [0052]

The present invention also relates to use of the chocolate-like food of the present invention for transporting and storing in a melted state. Specifically, the chocolate-like food of the present invention is used for transporting and storing in a melted state. The chocolate-like food “for transportation and storage in a melted state” means a chocolate-like food whose viscosity change is suppressed with maintaining a usable state including a flavor, even when stored in a melted state. Therefore, the present invention also relates to a method of suppressing a viscosity change during transportation and storage of the chocolate-like food in a melted state. Specifically, the method comprises preparing the chocolate-like food of the present invention and transporting and storing the chocolate-like food in a melted state, wherein a viscosity change is suppressed with maintaining the melted state.

According to the present invention, the chocolate-like food can endure transportation and storage in a melted state for 72 hours or longer. A viscosity change with time is within the range of desirably ±30%, more desirably ±20% at the stages of 7th day and 14th day, preferably also at the stage of 21st day relative to the value at the time of preparation (day 0), when measured at the same temperature. Sometimes, a large viscosity change with time adversely affects quantitativity upon use.

In the present invention, by measuring the viscosity after storage in a melted state at 50° C. for 9 days (216 hours) or longer, a tendency of a viscosity change thereafter can be predicted. That is, when a viscosity change at a stage of 9th day (216 hours) or later of storage in a melted state at 50° C. is within the range of ±30% relative to the value at the time of preparation (day 0), the chocolate-like food can be considered to endure transportation and storage in a melted state for 1000 hours, at least 500 hours from the time of its preparation.

### EXAMPLES

Hereinafter, Examples will be described. In Examples, all the “percents” and “parts” are by weight unless otherwise described. The rate of non-crystalline lactose was measured by an X-ray diffraction method.

### Examples 1 to 3 and Comparative Examples 1 to 3

Amount of non-fat milk solids to be incorporated, and test for viscosity increase in storage in melted state

First, a crystallization treatment of a whole milk powder was performed. A kneader controlled to 60° C. was charged with 1 kg of a whole milk powder, and 50 g of water was added thereto. These materials were heated and mixed as they were for 2 hours, and the mixture was pulverized with a mixer to obtain a whole milk powder in which a part of lactose was crystallized. The rate of non-crystalline lactose to total lactose was 83.4% by weight at this time. Further, all the crystals were of a β-type. On the other hand, the rate of non-crystalline lactose relative to total lactose in a whole milk powder which was not subjected to the crystallization treatment was 100% by weight. The numerical values of “Standard Tables of Food Composition in Japan, Fifth Revised and Enlarged Edition 2007” (Kagawa Nutrition University Publishing Division) were used as the total amount of lactose in the whole milk powder.

Then, trial production of white chocolate-like foods in accordance with the formulations of Table 1 (Examples 1 to 3) was performed by using the whole milk powder in which a part of lactose was crystallized. Raw materials were mixed and pulverized with a roll and conching was performed at 55° C. for 2 hours according to a conventional method. Then, after measuring viscosity on the day of preparation, about 600 g of the mixture was sealed in a royal can, and this was stored in an incubator of 50° C. Separately, similar trial production of chocolate-like foods was performed by using an untreated whole milk powder (Comparative Examples 1 to 3). The viscosity was measured with time until 10 days to evaluate white chocolate-like foods of Examples 1 to 3 and Comparative Examples 1 to 3. The measurement of viscosity was performed according to the following method.

Viscometer: BM-type Viscometer (manufactured by Toki Sangyo Co., Ltd.)

Rotor: No. 3 or No. 4

Rotor rotation number: 12 rpm

Measuring temperature: 50° C.

TABLE 1
Trial formulations in test for viscosity increase using
milk powder

| | Example 1 | Example 2 | Example 3 |
|---|---|---|---|
| | Comparative | Comparative | Comparative |
| Raw materials | Example 1 | Example 2 | Example 3 |
| Whole milk powder | 12.5 | 15.0 | 20.0 |
| (Example: crystallized | | | |
| Comparative Example: | | | |
| untreated) | | | |
| Sugar | 53.6 | 51.1 | 46.1 |
| Cacao butter | 33.9 | 33.9 | 33.9 |
| Lecithin | 0.5 | 0.5 | 0.5 |
| Total | 100.5 | 100.5 | 100.5 |

(The content of non-fat milk solids in a whole milk powder used was 70.8% by weight.)

When rates of non-crystalline lactose in lactose of Examples 1 to 3 in Table 1 were measured by the above-mentioned “X-ray diffraction method” using chocolate-like foods thus produced as test samples, they were 79.9% by weight, 81.2% by weight, and 80.5% by weight, respectively. Similarly, in Comparative Examples 1 to 3, rates of non-crystalline lactose were all 100% by weight.

Since rates of non-crystalline lactose relative to the total amount of lactose in the whole milk powders used in Examples 1 to 3 were 83.4% by weight as described above, it was revealed that the rate of non-crystalline lactose can be almost exactly measured by the X-ray diffraction method using the chocolate-like food as the test samples.

The results obtained by storing the chocolate-like foods of Examples 1 to 3 and Comparative Examples 1 to 3 at 50° C. are shown in Table 2.

TABLE 2
Viscosity change by storage at 50° C. (unit: P)

| | Number of days (days) | | | | | | | | | | |
|---|---|---|---|---|---|---|---|---|---|---|---|
| | 0 | 1 | 2 | 3 | 4 | 5 | 6 | 7 | 8 | 9 | 10 |
| ◯ Whole | | | | | | | | | | | |
| milk powder | | | | | | | | | | | |
| 12.5% | | | | | | | | | | | |
| Example 1 | 84.0 | 78.6 | 80.1 | — | — | 83.5 | 86.7 | 87.2 | — | 90.3 | — |
| Comparative | 81.3 | 84.0 | 130.0 | — | — | 176.0 | 187.5 | 242.5 | — | 415.0 | — |
| Example 1 | | | | | | | | | | | |
| ◯ Whole | | | | | | | | | | | |
| milk powder | | | | | | | | | | | |
| 15% | | | | | | | | | | | |
| Example 2 | 72.8 | 71.8 | 71.7 | — | 71.0 | — | — | 73.5 | 75.5 | 76.4 | 77.0 |
| Comparative | 66.0 | — | — | 166.0 | 213.5 | 188.0 | — | 272.5 | — | — | 382.5 |
| Example 2 | | | | | | | | | | | |
| ◯ Whole | | | | | | | | | | | |
| milk powder | | | | | | | | | | | |
| 20% | | | | | | | | | | | |
| Example 3 | 65.5 | — | — | 68.0 | 69.8 | 69.8 | — | 74.2 | — | — | 74.3 |
| Comparative | 58.6 | — | — | 130.0 | 142.5 | 139.0 | — | 171.5 | — | — | 157.0 |
| Example 3 | | | | | | | | | | | |

In Comparative Examples 1 to 3 wherein an untreated whole milk powder was used, a high viscosity increase was observed within 3 days, while in Examples 1 to 3 wherein a whole milk powder whose lactose was partly crystallized, was used, less viscosity increase was observed even after preservation for 10 days and, further, almost constant viscosity was maintained. Therefore, by subjecting a whole milk powder to a crystallization treatment of lactose, a viscosity increase which occurs in a heated/melted state was suppressed properly as compared with a case without the treatment.

When a flavor was evaluated by an organoleptic test, the flavor was good at the time of both 9th and 10th days.

### Example 4

First, 11.5 parts of cacao mass (product name: Fuji Cacao Mass 100, manufactured by Fuji Oil Co., Ltd.), 16.0 parts of a whole milk powder (product name: Yotsuba Whole Milk Powder, manufactured by Yotsuba Milk Products Co., Ltd.), 3.0 parts of a whey powder (product name: Confectionery Raw Flour I, manufactured by Snow Brand Milk Products Co., Ltd.), 13.5 parts of sugar, 4.0 parts of a palm fractionated low melting point oil (melting point 10° C., product name: Palm Ace 10, manufactured by Fuji Oil Co., Ltd.), 0.5 parts of distilled water, and 0.1 parts of soybean lecithin (product name: SLP-Paste, manufactured by Tsuji Oil Mills Co., Ltd., soybean origin) were subjected to a heat treatment in a covered container at a temperature of the mixture of 60° C. for 3 hours by heating the outer circumference of the container on an oil bath, while stirring and mixing with a mixer. Then, the mixture was subjected to a grain refining treatment with a roll refiner, and mixed with 20.0 parts of a coconut oil (product name: Purified Coconut Oil, manufactured by Fuji Oil Co., Ltd.), 31.0 parts of a palm fractionated low melting point oil, and 0.4 parts of soybean lecithin with a conching machine to prepare a milk chocolate-like food.

Regarding the resulting milk chocolate-like food, the flavor, color tone and texture were evaluated. Further, the food was packed into capped cans, and stored in an incubator of 40° C. and 50° C., respectively, and the viscosity and flavor thereof were evaluated after 0 day, after 3 days, after 7 days, after 14 days and after 21 days, respectively. The results of the evaluation are shown in Table 3.

### Comparative Example 4

According to the same manner as that of Example 4, a milk chocolate-like food was prepared except that the heat treatment time before the grain refining step was changed to 0.5 hours, and a similar evaluation was performed. The results of the evaluation are shown in Table 3.

### Comparative Example 5

According to the same manner as that of Example 4, a milk chocolate-like food was prepared except that the heat treatment time before the grain refining step was changed to 6 hours, and a similar evaluation was performed. The results of the evaluation are shown in Table 3.

### Comparative Example 6

According to the same manner as that of Example 4, a milk chocolate-like food was prepared except that the amount of the palm fractionated low melting point oil to be incorporated upon stirring and mixing with a mixer was changed to 4.5 parts, and the amount of distilled water was changed to 0 part, and a similar evaluation was performed. The results of the evaluation are shown in Table 3.

### Comparative Example 7

According to the same manner as that of Example 4, a milk chocolate-like food was prepared except that the amount of sugar to be incorporated upon stirring and mixing with a mixer was changed to 11.5 parts, and the amount of distilled water was changed to 2.5 parts, and a similar evaluation was performed. The results of the evaluation are shown in Table 3.

TABLE 3

| | | Com- | Com- | Com- | Com- |
|---|---|---|---|---|---|
| | | parative | parative | parative | parative |
| | Exam- | Exam- | Exam- | Exam- | Exam- |
| | ple 4 | ple 4 | ple 5 | ple 6 | ple 7 |
| Cacao mass | 11.5 | 11.5 | 11.5 | 11.5 | 11.5 |
| Whole milk powder | 16 | 16 | 16 | 16 | 16 |
| Whey powder | 3 | 3 | 3 | 3 | 3 |
| Sugar | 13.5 | 13.5 | 13.5 | 13.5 | 11.5 |
| Cocoa butter | 0.0 | 0.0 | 0.0 | 0.0 | 0.0 |
| Purified coconut oil | 20 | 20 | 20 | 20 | 20 |
| Palm fractionated low | 35 | 35 | 35 | 35.5 | 35 |
| melting point oil | | | | | |
| (melting point 10° C.) | | | | | |
| Distilled water | 0.5 | 0.5 | 0.5 | 0.0 | 2.5 |
| Lecithin | 0.5 | 0.5 | 0.5 | 0.5 | 0.5 |
| Water content in raw | 1.37 | 1.37 | 1.37 | 0.87 | 3.30 |
| materials (%) | | | | | |
| Content of milk | 18.4 | 18.4 | 18.4 | 18.4 | 18.4 |
| component | | | | | |
| (dry weight) (%) | | | | | |
| Content of vegetable | 55.0 | 55.0 | 55.0 | 55.0 | 55.0 |
| fats and oils other than | | | | | |
| cacao butter (%) | | | | | |
| Heating conditions by | 60° C. | 60° C. | 60° C. | 60° C. | 60° C. |
| completion of grain | 3 hours | 0.5 hours | 6 hours | 3 hours | 3 hours |
| refining step | | | | | |
| Flavor at the time of | 5 | 5 | 3 | 5 | 4 |
| preparation | | | | | |
| Color tone at the time | ◯ | ◯ | ◯ | ◯ | ◯ |
| of preparation | | | | | |
| Texture | ◯ | ◯ | ◯ | ◯ | X |

Viscosity after storing at 40° C.

| | | | | | |
|---|---|---|---|---|---|
| 0th day | 295 | 320 | 290 | 290 | 380 |
| 3rd day | 320 | 400 | 310 | 360 | 400 |
| 7th day | 315 | 2060 | 330 | 1050 | 450 |
| 14th day | 325 | 5100 | 320 | 3020 | 450 |
| 21st day | 340 | 5250 | 335 | 3500 | 500 |

Viscosity after storing at 50° C.

| | | | | | |
|---|---|---|---|---|---|
| 0th day | 295 | 320 | 290 | 290 | 380 |
| 3rd day | 300 | 3020 | 300 | 2680 | 400 |
| 7th day | 320 | 1800 | 330 | 1750 | 450 |
| 14th day | 330 | 1360 | 325 | 1500 | 460 |
| 21st day | 350 | 1220 | 335 | 1550 | 480 |

Flavor after storing at 40° C.

| | | | | | |
|---|---|---|---|---|---|
| 0th day | 5 | 5 | 3 | 5 | 4 |
| 3rd day | 5 | 5 | 3 | 5 | 4 |
| 7th day | 5 | 5 | 3 | 5 | 3 |
| 14th day | 4 | 4 | 2 | 4 | 3 |
| 21st day | 4 | 4 | 2 | 4 | 2 |

Flavor after storing at 50° C.

| | | | | | |
|---|---|---|---|---|---|
| 0th day | 5 | 5 | 3 | 5 | 4 |
| 3rd day | 5 | 5 | 3 | 5 | 4 |
| 7th day | 4 | 4 | 2 | 4 | 3 |
| 14th day | 3 | 3 | 2 | 3 | 2 |
| 21st day | 3 | 3 | 2 | 3 | 2 |

In the chocolate-like foods prepared in Example 4 and Comparative Examples 4 and 6, the rates of non-crystalline lactose relative to total lactose were 82.9% by weight, 100% by weight and 100% by weight, respectively.

### Evaluation Method of the Above-Prepared Chocolate-Like Foods

Evaluation of flavor at the time of preparation and after storage: Taste evaluation was performed based on the following criteria.

“5: extremely good flavor”

“4: slightly off-taste, but good”

“3: off-taste, but marketable”

“2: off-taste, and no commercial value”

“1: intolerable off-taste”

Color tone evaluation: The evaluation was performed visually based on the following criteria.

“∘: extremely good color tone”

“Δ: strange color tone, but marketable”

“Δ: strange color tone, and no commercial value”

Texture evaluation: The evaluation was performed visually based on the following criteria.

“∘: extremely good texture”

“Δ: slightly rough texture, but marketable”

“×: sever roughness, and no commercial value”

Evaluation of viscosity after storage: The viscosity of a stored chocolate-like food was measured with a BM-type viscometer (manufactured by Toki Sangyo Co., Ltd.) at 30 rpm and 45° C. with appropriately selecting an optimal rotor. The viscosity in the table is expressed in “cP” units.

### Example 5

According to the same manner as that of Example 4, a milk chocolate-like food was prepared except that the heating temperature was changed to 80° C., and a similar evaluation was performed. The results of the evaluation are shown in Table 4.

### Comparative Example 8

According to the same manner as that of Example 4, a milk chocolate-like food was prepared except that the heating temperature was changed to 95° C., and a similar evaluation was performed. The results of the evaluation are shown in Table 4.

### Examples 6

According to the same manner as that of Example 4, a milk chocolate-like food was prepared except that the amount of cacao mass to be incorporated upon stirring and mixing with a mixer was changed to 16.4 parts, the amount of the whole milk powder was changed to 22.2 parts, the amount of the whey powder was changed to 0 part, the amount of sugar was changed to 44.2 parts, the amount of cocoa butter was changed to 13 parts, the amount of the palm fractionated low melting point oil was changed to 0 part, the amount of cocoa butter to be mixed with a conching machine was changed to 5 parts, the amount of the purified palm oil was changed to 0 part, and the amount of the palm fractionated low melting point oil was changed to 0 part, and a similar evaluation was performed. The results of the evaluation are shown in Table 4.

### Reference Example 2

According to the same manner as that of Comparative Example 5, a milk chocolate-like food was prepared except that the amount of the whole milk powder to be incorporated upon stirring and mixing with a mixer was changed to 6 parts, the amount of sugar was changed to 30 parts, the amount of the palm fractionated low melting point oil was changed to 7 parts, and the amount of distilled water was changed to 0 part, the purified coconut oil to be mixed with a conching machine was changed to 19 parts, and the amount of the palm fractionated low melting point oil was changed to 26 parts, and a similar evaluation was performed. The results of the evaluation are shown in Table 4.

TABLE 4

| | | Comparative | | Reference |
|---|---|---|---|---|
| | Example 5 | Example 8 | Example 6 | Example 2 |
| Cacao mass | 11.5 | 11.5 | 14.6 | 11.5 |
| Whole milk powder | 16 | 16 | 22.2 | 6.0 |
| Whey powder | 3 | 3 | 0.0 | 0.0 |
| Sugar | 13.5 | 13.5 | 44.2 | 30.0 |
| Cocoa butter | 0.0 | 0.0 | 18.0 | 0.0 |
| Purified coconut oil | 20 | 20 | 0.0 | 19.0 |
| Palm fractionated low | 35 | 35 | 0.0 | 33.0 |
| melting point oil | | | | |
| (melting point 10° C.) | | | | |
| Distilled water | 0.5 | 0.5 | 0.5 | 0.0 |
| Lecithin | 0.5 | 0.5 | 0.5 | 0.5 |
| Water content in raw | 1.37 | 1.37 | 1.68 | 0.56 |
| materials (%) | | | | |
| Content of milk | 18.4 | 18.4 | 21.5 | 5.8 |
| component | | | | |
| (dry weight) (%) | | | | |
| Content of vegetable | 55.0 | 55.0 | 0.0 | 52.0 |
| fats and oils other | | | | |
| than cacao butter (%) | | | | |
| Heating conditions by | 80° C. | 95° C. | 60° C. | 60° C. |
| completion of grain | 3 hours | 3 hours | 3 hours | 0.5 hours |
| refining step | | | | |
| Flavor at the time of | 4 | 3 | 5 | 5 |
| preparation | | | | |
| Color tone at the time | ◯ | Δ | ◯ | ◯ |
| of preparation | | | | |
| Texture | ◯ | X | ◯ | ◯ |

Viscosity after storage at 40° C.

| | | | | |
|---|---|---|---|---|
| 0th day | 305 | 290 | 14000 | 310 |
| 3rd day | 305 | 295 | 14000 | 310 |
| 7th day | 310 | 295 | 16000 | 305 |
| 14th day | 310 | 300 | 18000 | 315 |
| 21st day | 320 | 310 | 20000 | 320 |

Viscosity after storage at 50° C.

| | | | | |
|---|---|---|---|---|
| 0th day | 305 | 290 | 14000 | 310 |
| 3rd day | 310 | 290 | 14000 | 315 |
| 7th day | 310 | 295 | 18000 | 315 |
| 14th day | 320 | 310 | 21500 | 320 |
| 21st day | 335 | 330 | 24000 | 340 |

Flavor after storage at 40° C.

| | | | | |
|---|---|---|---|---|
| 0th day | 4 | 3 | 5 | 5 |
| 3rd day | 4 | 3 | 5 | 5 |
| 7th day | 4 | 3 | 5 | 5 |
| 14th day | 4 | 3 | 4 | 5 |
| 21st day | 3 | 2 | 3 | 4 |

Flavor after storage at 50° C.

| | | | | |
|---|---|---|---|---|
| 0th day | 4 | 3 | 5 | 5 |
| 3rd day | 4 | 3 | 5 | 5 |
| 7th day | 3 | 3 | 4 | 5 |
| 14th day | 3 | 2 | 3 | 4 |
| 21st day | 3 | 2 | 3 | 3 |

In Example 4, there was no problem in the flavor, color tone, and texture at the initial stage, and a viscosity change and a flavor change after storage were little. Therefore, it could be said that the chocolate-like food sufficiently endured transportation and storage in a melted state.

In contrast to Example 4, in Comparative Example 4 wherein the heat treatment time before the grain refining step was changed to 0.5 hours, the viscosity change after storage in a melted state (40° C. and 50° C.) was drastic, and this damaged the commercial value.

In contrast to Example 4, in Comparative Example 5 wherein the heat treatment time before the grain refining step was changed to 6 hours, a caramel-like flavor was manifested, and the result of the flavor evaluation at the time of the preparation was slightly inferior. In addition, deterioration of the flavor after storage in a melted state (40° C. and 50° C.) was fast, and the commercial value was somewhat low.

In Comparative Example 6 wherein water was not added and the water content of the raw materials was 0.87%, the viscosity change after storage in a melted state (40° C. and 50° C.) was drastic, and the commercial value was damaged.

In Comparative Example 7 wherein water was added in an amount of 2.5% and the water content in the raw materials was 3.30%, deterioration of the flavor after storage in a melted state (40° C. and 50° C.) was somewhat fast, the texture of the chocolate-like food became rough, and the commercial value was damaged.

In Example 5 wherein the heating temperature was changed to 80° C., the flavor at the initial stage was somewhat inferior as compared with Example 4, but there was no problem in the color tone and texture. Further, the viscosity change and the flavor change after storage were little. Therefore, it could be said that the food sufficiently endured transportation and storage in a melted state.

In Comparative Example 8 wherein the heating temperature was changed to 95° C., a burnt deposit was generated, and the flavor, color tone and texture at the initial stage were inferior.

In Example 6 wherein the content of vegetable fats and oils was low and the food was obtained under the same conditions as those of Example 4, although the addition of water and the heat treatment were performed, the viscosity tended to increase with time, and the commercial value was somewhat low.

In Reference Example 2 wherein the milk component was added in a smaller amount and the food was obtained under the same conditions as those of Comparative Examples 4, the chocolate-like food sufficiently endured transportation and storage in a melted state despite of the insufficient water content and heating time.

### Example 7

First, 6.0 parts of a whole milk powder, 7.0 parts of a skim milk powder (product name: Yotsuba Skim Milk Powder, manufactured by Yotsuba Milk Products Co., Ltd.), 30.0 parts of sugar, 16.5 parts of a palm fractionated low melting point oil, 1.5 parts of fresh cream (product name: Tokachi Fresh Cream 47, manufactured by Meiji Co., Ltd.), and 0.1 parts of soybean lecithin were subjected to a heat treatment in a covered container at a temperature of the mixture of 60° C. for 3 hours by heating the outer circumference of the container on an oil bath while stirring and mixing with a mixer. Then, the mixture was subjected to a grain refining treatment with a roll refiner, and mixed with 10.0 parts of a cocoa butter, 10.0 parts of a soybean oil (product name: Soybean Sirashime Oil manufactured by Fuji Oil Co., Ltd.), 18.5 parts of a palm fractionated low melting point oil, and 0.4 parts of soybean lecithin with a conching machine to prepare a white chocolate-like food, and a similar evaluation was performed. The results of the evaluation are shown in Table 5.

### Comparative Example 9

According to the same manner as that of Example 4, a white chocolate-like food was prepared except that the heat treatment time before the grain refining step was changed to 0.5 hours, and a similar evaluation was performed. The results of the evaluation are shown in Table 5.

### Comparative Example 10

According to the same manner as that of Example 4, a white chocolate-like food was prepared except that the heat treatment before the grain refining step was changed to 6 hours, and a similar evaluation was performed. The results of the evaluation are shown in Table 5.

### Comparative Example 11

According to the same manner as that of Example 4, a white chocolate-like food was prepared except that the amount of the palm fractionated low melting point oil to be incorporated upon stirring and mixing with a mixer was changed to 18.0 parts, and the amount of the fresh cream was changed to 0 part, and a similar evaluation was performed. The results of evaluation are shown in Table 5.

### Comparative Example 12

According to the same manner as that of Example 4, a white chocolate-like food was prepared except that the amount of sugar to be incorporated upon stirring and mixing with a mixer was changed to 28 parts, the amount of the palm fractionated low melting point was changed to 15.0 parts, and the amount of the fresh cream was changed to 5 parts, and a similar evaluation was performed. The results of evaluation are shown in Table 5.

TABLE 5

| | | Com- | Com- | Com- | Com- |
|---|---|---|---|---|---|
| | | parative | parative | parative | parative |
| | Exam- | Exam- | Exam- | Exam- | Exam- |
| | ple 7 | ple 9 | ple 10 | ple 11 | ple 12 |
| Whole milk powder | 6.0 | 6.0 | 6.0 | 6.0 | 6.0 |
| Skim milk powder | 7.0 | 7.0 | 7.0 | 7.0 | 7.0 |
| Sugar | 30.0 | 30.0 | 30.0 | 30.0 | 28.0 |
| Cocoa butter | 10.0 | 10.0 | 10.0 | 10.0 | 10.0 |
| Palm fractionated low | 35.0 | 35.0 | 35.0 | 36.5 | 33.5 |
| melting point oil | | | | | |
| (melting point 10° C.) | | | | | |
| Soybean oil | 10.0 | 10.0 | 10.0 | 10.0 | 10.0 |
| Fresh cream | 1.5 | 1.5 | 1.5 | 0.0 | 5.0 |
| Lecithin | 0.5 | 0.5 | 0.5 | 0.5 | 0.5 |
| Water content in raw | 1.33 | 1.33 | 1.33 | 0.60 | 3.02 |
| materials (%) | | | | | |
| Content of milk | 13.3 | 13.3 | 13.3 | 13.3 | 13.3 |
| component | | | | | |
| (dry weight) (%) | | | | | |
| Content of vegetable | 45.0 | 45.0 | 45.0 | 46.5 | 43.5 |
| fats and oils other | | | | | |
| than cacao butter (%) | | | | | |
| Heating conditions by | 60° C. | 60° C. | 60° C. | 60° C. | 60° C. |
| completion of grain | 3 hours | 0.5 hours | 6 hours | 3 hours | 3 hours |
| refining step | | | | | |
| Flavor at the time of | 5 | 5 | 3 | 5 | 4 |
| preparation | | | | | |
| Color tone at the time | ◯ | ◯ | Δ | ◯ | ◯ |
| of preparation | | | | | |
| Texture | ◯ | ◯ | ◯ | ◯ | X |

Viscosity after storage at 40° C.

| | | | | | |
|---|---|---|---|---|---|
| 0th day | 465 | 475 | 450 | 445 | 520 |
| 3rd day | 460 | 505 | 450 | 520 | 520 |
| 7th day | 460 | 1050 | 445 | 980 | 530 |
| 14th day | 465 | 2250 | 455 | 1750 | 555 |
| 21st day | 470 | 2500 | 470 | 2100 | 560 |

Viscosity after storage at 50° C.

| | | | | | |
|---|---|---|---|---|---|
| 0th day | 465 | 475 | 450 | 445 | 520 |
| 3rd day | 465 | 950 | 450 | 820 | 515 |
| 7th day | 470 | 2100 | 465 | 1950 | 530 |
| 14th day | 480 | 2850 | 470 | 2700 | 560 |
| 21st day | 490 | 2300 | 480 | 2800 | 580 |

Flavor after storage at 40° C.

| | | | | | |
|---|---|---|---|---|---|
| 0th day | 5 | 5 | 3 | 5 | 4 |
| 3rd day | 5 | 5 | 3 | 5 | 4 |
| 7th day | 5 | 5 | 3 | 5 | 3 |
| 14th day | 4 | 5 | 2 | 5 | 3 |
| 21st day | 4 | 4 | 2 | 4 | 2 |

Flavor after storage at 50° C.

| | | | | | |
|---|---|---|---|---|---|
| 0th day | 5 | 5 | 3 | 5 | 4 |
| 3rd day | 5 | 5 | 3 | 5 | 4 |
| 7th day | 4 | 4 | 2 | 4 | 3 |
| 14th day | 3 | 3 | 2 | 3 | 2 |
| 21st day | 3 | 3 | 2 | 3 | 2 |

In Example 7, there was no problem in the flavor, color tone and texture at the initial stage, and the viscosity change and the flavor change after storage were little. Therefore, it could be said that the chocolate-like food sufficiently endured transportation and storage in a melted state.

In contrast to Example 7, in Comparative Example 9 wherein the heat treatment time before the grain refining step was changed to 0.5 hours, the viscosity change after storage in a melted state (40° C. and 50° C.) was drastic, and the commodity value was damaged.

In contrast to Example 7, in Comparative Example 10 wherein the heat treatment time before the grain refining step was changed to 6 hours, the color tone was slightly yellowish and somewhat unnatural. In addition, a caramel-like flavor was manifested and, consequently, the flavor evaluation at the time of preparation was somewhat inferior. Deterioration of the flavor after storage in a melted state (40° C. and 50° C.) was fast and the chocolate-like food could not be regarded as having sufficient durability for in transportation and storage in a melted state, and the commercial value was low.

In Comparative Example 11 wherein water was not added and the water content in raw materials was 0.60%, the viscosity change after storage in a melted state (40° C. and 50° C.) was drastic, and the commercial value was damaged.

In Comparative Example 12 wherein the fresh crease was added in an amount of 0.5% (corresponding to 2.4% in terms of water) and the water content in raw materials was 3.02%, deterioration of the flavor after storage in a melted state (40° C. and 50° C.) was somewhat fast, the texture of the chocolate-like food became rough, and the commercial value was damaged.

### Example 8

First, 7.5 parts of cacao mass, 2.5 parts of a cocoa powder (product name: Azteca Cocoa Powder N12, manufactured by Meiji Co., Ltd.), 12.0 parts of a whole milk powder, 35.5 parts of sugar, 8.0 parts of lactose, 12.5 parts of a hydrogenated palm kernel oil (melting point 38° C., product name: New Melarin 38, manufactured by Fuji Oil Co., Ltd.), 6.0 parts of unsalted butter (product name: Zen Noh Butter (salt free), manufactured by Tsukuba Dairy Products Co., Ltd.), and 0.1 parts of soybean lecithin were subjected to heat treatment in a container at a temperature of the mixture of 55° C. for 4 hours by heating the outer circumference of the container on an oil bath while stirring and mixing with a mixer. Then, the mixture was subjected to a grain refining treatment with a roll refiner, and mixed with 10.5 parts of hydrogenated palm kernel oil, 5.0 parts of palm fractionated low melting point oil, and 0.4 parts of soybean lecithin with a conching machine to prepare a milk chocolate-like food, and a similar evaluation was performed. The results of the evaluation are shown in Table 6.

### Comparative Example 13

According to the same manner as that of Example 8, a milk chocolate-like food was prepared except that the heat treatment time before the grain refining step was changed to 0.5 hours, and a similar evaluation was performed. The results of the evaluation are shown in Table 6.

### Comparative Example 14

According to the same manner as that of Example 8, a milk chocolate-like food was prepared except that the heat treatment time before the grain refining step was changed to 6 hours, and a similar evaluation was performed. The results of the evaluation are shown in Table 6.

### Comparative Example 15

According to the same manner as that of Example 8, a milk chocolate-like food was prepared except that the amount of the unsalted butter to be incorporated upon stirring and mixing with a mixer was changed to 0 part, and the amount of the palm fractionated low melting point oil was changed to 6 parts, and a similar evaluation was performed. The results of the evaluation are shown in Table 6.

TABLE 6

| | | Comparative | Comparative | Comparative |
|---|---|---|---|---|
| | Example 8 | Example 13 | Example 14 | Example 15 |
| Cacao mass | 7.5 | 7.5 | 7.5 | 7.5 |
| Cocoa powder | 2.5 | 2.5 | 2.5 | 2.5 |
| Whole milk | 12 | 12 | 12 | 12 |
| powder | | | | |
| Lactose | 8 | 8 | 8 | 8 |
| Sugar | 35.5 | 35.5 | 35.5 | 35.5 |
| Hardened palm | 23 | 23 | 23 | 23 |
| kernel oil | | | | |
| (melting point | | | | |
| 38° C.) | | | | |
| Palm fractionated | 5 | 5 | 5 | 11 |
| low melting | | | | |
| point oil (melting | | | | |
| point 10° C.) | | | | |
| Unsalted butter | 6 | 6 | 6 | 0 |
| Lecithin | 0.5 | 0.5 | 0.5 | 0.5 |
| Water content in | 1.79 | 1.79 | 1.79 | 0.83 |
| raw materials (%) | | | | |
| Content of milk | 16.7 | 16.7 | 16.7 | 12.5 |
| component | | | | |
| (dry weight) (%) | | | | |
| Content of | 28.0 | 28.0 | 28.0 | 33.0 |
| vegetable fats | | | | |
| and oils other | | | | |
| than cacao butter | | | | |
| (%) | | | | |
| Heating | 55° C. | 55° C. | 55° C. | 55° C. |
| conditions by | 4 hours | 0.5 hours | 6 hours | 4 hours |
| completion of | | | | |
| grain refining step | | | | |
| Flavor at the time | 5 | 5 | 3 | 5 |
| of preparation | | | | |
| Color tone at the | ◯ | ◯ | ◯ | ◯ |
| time of | | | | |
| preparation | | | | |
| Texture | ◯ | ◯ | ◯ | ◯ |

Viscosity after storage at 40° C.

| | | | | |
|---|---|---|---|---|
| 0th day | 7500 | 7500 | 7500 | 6950 |
| 3rd day | 7500 | 7650 | 7550 | 7150 |
| 7th day | 7500 | 8150 | 7500 | 7650 |
| 14th day | 7550 | 8550 | 7550 | 8250 |
| 21st day | 7600 | 8850 | 7600 | 8350 |

Viscosity after storage at 50° C.

| | | | | |
|---|---|---|---|---|
| 0th day | 7500 | 7500 | 7500 | 6950 |
| 3rd day | 7500 | 7650 | 7500 | 7100 |
| 7th day | 7500 | 8600 | 7600 | 7450 |
| 14th day | 7600 | 10000 | 7600 | 10850 |
| 21st day | 7700 | 11000 | 7700 | 11250 |

Flavor after storage at 40° C.

| | | | | |
|---|---|---|---|---|
| 0th day | 5 | 5 | 3 | 5 |
| 3rd day | 5 | 5 | 3 | 5 |
| 7th day | 5 | 5 | 3 | 5 |
| 14th day | 4 | 4 | 2 | 4 |
| 21st day | 3 | 3 | 2 | 3 |

Flavor after storage at 50° C.

| | | | | |
|---|---|---|---|---|
| 0th day | 5 | 5 | 3 | 5 |
| 3rd day | 5 | 5 | 3 | 5 |
| 7th day | 4 | 4 | 2 | 4 |
| 14th day | 3 | 3 | 2 | 3 |
| 21st day | 3 | 3 | 1 | 3 |

In Example 8, there was no problem in the flavor, color tone, and texture at the initial stage, and the viscosity change and the flavor change after storage were small. Therefore, it could be said that the chocolate-like food sufficiently endured transportation and storage in a melted state.

In contrast to Example 8, in Comparative Example 13, wherein the heat treatment time before the grain refining step was changed to 0.5 hours, the viscosity change after storage in a melted state (40° C. and 50° C.) was large, and the commercial value was damaged.

In contrast to Example 8, in Comparative Example 14, wherein the heat treatment time before the grain refining step was changed to 6 hours, a caramel-like flavor was manifested and, consequently, the evaluation of the flavor at the time of preparation was somewhat inferior. Deterioration of the flavor after storage in a melted state (40° C. and 50° C.) was fast, and the commercial value was somewhat low.

In Comparative Example 15, wherein butter was not added and the water content in raw materials was 0.83%, the viscosity change after storage in a melted state (40° C. and 50° C.) was somewhat large, and the commercial value was somewhat low.

### INDUSTRIAL APPLICABILITY

The present invention enables manufactures to apply a chocolate-like food, in particular, a chocolate-like food containing a large amount of a milk component to transportation and storage in a melted state by a simple and convenient method, and can be utilized in the field of confectionery production and foods.

1. A chocolate-like food for transportation and storage in a melted state, which comprises 7 to 23% by weight of non-fat milk solids, wherein a rate of non-crystalline lactose to total lactose contained therein is 85% by weight or less.

2. A method of suppressing a change in viscosity of a chocolate-like food in a melted state with time, which comprises preparing a chocolate-like food comprising 7 to 23% by weight of non-fat milk solids, wherein a rate of non-crystalline lactose to total lactose contained therein is 85% by weight or less, and transporting and storing the chocolate-like food in a melted state.

3. A process for producing the chocolate-like food for transportation and storage in a melted state according to claim 1, which comprises regulating a formulation of raw materials so that a water content of the final chocolate-like food becomes 0.9 to 2.7% by weight and, thereafter, performing a heat treatment at 55 to 90° C. for 1 hour or longer and shorter than 6 hours by the completion of a grain refining step.

4. The process for producing the chocolate-like food for transportation and storage in a melted state according to claim 3, wherein the final chocolate-like food contains 9 to 50% by weight of a milk component in terms of dry weight.

5. The process for producing the chocolate-like food for transportation and storage in a melted state according to claim 4, wherein the final chocolate-like food contains 10 to 75% by weight of vegetable fats and oils other than cacao butter.

6. The process for producing the chocolate-like food for transportation and storage in a melted state according to claim 5, which is applied to transportation and storage in a melted state for 72 hours or longer.

7. A process for producing the chocolate-like food for transportation and storage in a melted state according to claim 1, which comprises preparing a milk powder having a rate of non-crystalline lactose of 85% by weight or less to total lactose contained therein, and using the resulting milk powder as a raw material of the chocolate-like food.

8. The process for producing the chocolate-like food for transportation and storage in a melted state according to claim 7, wherein the milk powder having a rate of non-crystalline lactose of 85% by weight or less to total lactose contained therein is obtained by adding water to a milk powder, followed by heating and mixing at 55 to 90° C., and the resulting milk powder is used as the raw material.

9. The process for producing the chocolate-like food for transportation and storage in a melted state according to claim 3, wherein lactose is separately added as a sugar component in an amount of less than 5% by weight based on the chocolate-like food.

10. The process for producing the chocolate-like food for transportation and storage in a melted state according to claim 4, wherein lactose is separately added as a sugar component in an amount of less than 5% by weight based on the chocolate-like food.

11. The process for producing the chocolate-like food for transportation and storage in a melted state according to claim 5, wherein lactose is separately added as a sugar component in an amount of less than 5% by weight based on the chocolate-like food.

12. The process for producing the chocolate-like food for transportation and storage in a melted state according to claim 6, wherein lactose is separately added as a sugar component in an amount of less than 5% by weight based on the chocolate-like food.

13. The process for producing the chocolate-like food for transportation and storage in a melted state according to claim 7, wherein lactose is separately added as a sugar component in an amount of less than 5% by weight based on the chocolate-like food.

14. The process for producing the chocolate-like food for transportation and storage in a melted state according to claim 8, wherein lactose is separately added as a sugar component in an amount of less than 5% by weight based on the chocolate-like food.
